(19) United States
(12) Patent Application Publication
(10) Pub. No.: US 2013/0218687 A1
(43) Pub. Date: Aug. 22, 2013

(54) Methods, systems and devices for determining a user interest and/or characteristic by employing a personalization engine

(71) Applicants: Sina Sohangir, Menlo Park, CA (US); Shahram Syedin-Noor, San Francisco, CA (US); Navid Zarghami, San Jose, CA (US)

(72) Inventors: Sina Sohangir, Menlo Park, CA (US); Shahram Syedin-Noor, San Francisco, CA (US); Navid Zarghami, San Jose, CA (US)

(73) Assignee: GRAPHDIVE, INC., Menlo Park, CA (US)

(21) Appl. No.: 13/556,058

(22) Filed: Jul. 23, 2012

Related U.S. Application Data
(60) Provisional application No. 61/600,406, filed on Feb. 17, 2012.

(51) Int. Cl. G06Q 30/02; G06Q 30/00; G06F 17/30

(52) U.S. Cl. 705/14.66; 707/783; 705/26.3; 707/E17.005

(57) ABSTRACT

A user interest and/or characteristic may be determined when permission to access personal information associated with a user account stored in a database operated by a third party, such as a social media network or service, is received. Accessed personal information may be evaluated using different criteria and a concept graph relating a plurality of words and concepts to one another, and an interest and/or characteristic of the user may then be determined based on the evaluation. Accessed personal information may also be evaluated using different criteria, including proprietary algorithms, probabilistic distributions, and a generated concept graph, to determine a price recommendation for a given offer for the user, or the price sensitivity of the user generally. A user's response to personalized offerings and/or terms based upon this evaluation may then be used to determine more refined interests, characteristics, and/or pricing terms in an iterative process.

### CROSS-REFERENCE TO RELATED APPLICATION

This application is a NONPROVISIONAL of, claims priority to, and incorporates by reference in its entirety U.S. Provisional Patent Application 61/600,406 filed 17 Feb. 2012.

### FIELD OF INVENTION

This invention relates to methods, apparatus, and systems for determining a user interest and/or characteristic.

### BACKGROUND

Technology underpins the emergence, adoption, and popularity of social networks such as Friendster, Facebook™, Google+ and Twitter that have created rich new data about users that can be used to understand both their explicit (direct or literal, as outlined below) and implicit interests. For example, a user who explicitly mentions or endorses Kobe Bryant or LeBron James on his social media profile may be assumed to be implicitly interested in the sport of basketball. A user who posts vacation photos from his trip to Playa del Carmen, Mexico, may be assumed to be implicitly interested in sunny vacation spots and/or a host of other related things. Social graph data in the context of social media technology presents a large and largely untapped resource for better understanding users and their needs, interests, wants, and characteristics.

Typically information available on a social network provider for determining an interest or characteristic of a user is gathered either by a user's direct, or explicit, expression of interest or by indirect observation of user behavior and literal deduction of a user's interests based on this behavior. For instance, if a user proclaims on his social network profile on the Internet that he is interested in tennis, it is likely that he is, in fact, interested in tennis. Likewise, if user behavior consistent with an interest in tennis is observed, (e.g., purchase of a tennis racket or tennis lessons), it is also likely that he is, in fact, interested in tennis. However, reliance upon such literal deduction of user interests has many drawbacks. For example, not all user interests are easily understood via literal deduction: if a user expresses an interest in a particular tennis club, he may be interested in any number of things related, or unrelated, to tennis (e.g., a restaurant inside the club, or the fact that the club has high-profile celebrity patrons).

Further, the explicit and implicit signals in a user's social media profile may indicate preferences or characteristics of the user related to her price elasticity (or sensitivity) or eligibility for certain discounts or promotions with respect to purchases. For example, if a computer system deduced through analysis of a user's social network profile information—such as the demographic characteristics of other users or “friends” that she is connected to—that the user is a student, then the user may be eligible for applicable student discounts. Similarly, if the computer system deduced that a user is affluent, then specific promotions and prices for such promotions can be tailored for the user. To give yet another example, if it is determined that a user is a senior citizen, then promotions oriented toward known interests of senior citizens, as well as personalized pricing for them (e.g., specific senior citizen or AARP (American Association of Retired Persons) discounts), may be provided to the user.

### SUMMARY

The present invention describes methods, systems, devices, and computer readable media for (1) determining or approximating a user interest and/or characteristic by collecting and analyzing user social data through a personalization engine, and (2) determining or estimating an offer price and/or related deal terms through a price personalization engine using user social data and the user interests and/or characteristics derived therefrom, with both (1) and (2) achieved with the aid of advanced natural language processing and semantic analysis, probabilistic algorithms and machine learning. A price personalization engine may include a user profile approximator module for analyzing user social data and a price range determination module that functions through a machine-learning loop. The user profile approximator module may be configured to analyze a user's own social data and social data connected to the user's social data (i.e., the data from the user's friends) to deduce the user's interests or characteristics. The output from the user profile approximator module may be sent to the price range determination module, which is configured to (1) recommend an offer price by considering the analyzed social data and/or various probabilistic distributions to maximize the likelihood that the user will accept the offer price, (2) present the offer price or price related term to the user, and (3) provide user actions (such as acceptance or declination of an offer, comments, or inaction) to a machine learning module to maximize the revenues generated, or any other relevant metric, for that transaction.

Permission to access personal information associated with a user account stored in a database operated by a third party, such as a social media network or service, may be received via, for example, an interface communicatively coupled to the processor and the database. Once permission is received, the personal information (for example, information provided by the user's social networking friends, contacts and associates, including his interaction with this network) may be accessed and evaluated using a previously generated concept graph relating a plurality of words and concepts to one another. In some instances, weighted relationships between the words and concepts included in the concept graph may be calculated and/or incorporated into the concept graph. In one embodiment, an identity, status, and/or characteristic of the user may be inferred, generated and/or validated based on this evaluation. In addition, information provided by the user's social networking friends, contacts and associates, including his interaction with this network, may be evaluated to determine the characteristics and interests of the user's friends or contacts. In one embodiment, an identity, status, and/or characteristic of the user may be validated based on this social network evaluation.

An interest and/or characteristic of the user may then be determined based on these aggregated evaluations. An interest or characteristic may be, for example, anything directly or indirectly referred to in, or inferred from, the personal information. Exemplary interests and/or characteristics include a relationship, a sport, a product, a geographic location, a hobby, a skill, an experience, a club, an institution, and an event.

In one embodiment, an interest or characteristic of the user may be determined based upon an analysis or evaluation of social relationships the user engages in via a social network. For example, the number of “friends” a user is connected with via the social network, and/or certain characteristics or interests of such “friends” (such as, for example, their age, education or marital status), may be evaluated in order to determine a characteristic or interest of the user (such as, for example, his age, education or marital status) which in turn could be used to determine the user's price sensitivity for a particular good or service.

On some occasions, a notification may be provided to a third party responsively to the determined interest and/or characteristic. Optionally, the concept graph, the personal profile, the interests, and/or characteristics may be updated on, for example, a periodic or an as-needed basis and/or stored in a database. On some occasions, the updating may be responsive to monitoring and/or analyzing the user's interactions with, for example, the user account or a website.

In some embodiments, a recommendation may be determined based on the interest and/or characteristic and provided to the user and/or a third party. Exemplary recommendations include product, content, service, and/or pricing recommendations. On some occasions, a personalized price or discount for an offer directed to the user may be determined based on the evaluation. In other embodiments, a term of an offer (e.g., price, quantity, product feature) presented to the user may be determined based on the interest and/or characteristic.

In one instance, a user's price sensitivity to a product or offer may be determined based upon the evaluation and provided to a third party. In some cases, a user's price sensitivity to an offer indicates a price, or a range of prices, the user is likely to pay for acceptance of an offer or purchase of an item. On some occasions, results of the evaluation and/or a determined interest and/or characteristic may be used to determine a probability that a user will act upon, or accept, an offer.

On some occasions, results of the evaluation and/or a determined interest and/or characteristic may be used to determine a value (economic or otherwise) of the user as a prospective viewer of an advertisement or endorser of a product or service.

In another embodiment, a request for an interest and/or characteristic associated with a user may be received from a third party, such as an advertiser or other online business. The request may include permission to access the personal information associated with a user. The personal information associated with a user may then be accessed and a personal profile of the user may be generated based on the accessed information. The personal profile may then be evaluated using a previously generated concept graph relating a plurality of key words and concepts to one another and an interest and/or characteristic of the user may be determined based on the evaluation. The interest and/or characteristic may then be provided to the third party.

In a further embodiment, a request for permission to access personal information associated with a user from a user account stored in a database operated by a social networking service (such as Facebook) may be made via an interface (such as Facebook Connect) communicatively coupled to the processor and the database. Once permission is received, the personal information may be accessed and evaluated in order to determine a probability that at least one of an interest and a characteristic are associated with the user based on the evaluation. The probability may then be provided to a third party.

Another implementation of the presently described invention includes providing a user using a web site with a proposal for purchase of a selected good or service at a specified price. When the user visits the web site, user information may be automatically retrieved from a social network profile associated with the user. Access to the social network profile associated with the user may be facilitated through provision, by the user, of information sufficient for a retrieval process associated with the web site to satisfy authentication means employed by a social network site associated with the social network profile.

The user information and a concept graph may then be used to automatically construct a user profile that defines the user. Typically, but not always, the concept graph may be a construct that relates concepts, terms, and phrases to one another. The user profile may define the user in terms sufficient to permit automated selection of proposals, each at a respective specified price, deemed likely to be of interest to the user. Each proposal may be priced uniquely for the user according to the user profile constructed from the user information. One or more of the proposal(s) may then be presented for consideration by the user.

Exemplary systems disclosed herein include a processor, an interface, and a communication network. The processor may be configured to (1) communicate with a source of concept graph information via a communication port, (2) receive permission to access personal information associated with a user from the user and the third party social media network or service via a user interface communicatively coupled to the processor, (3) access the personal information, (4) generate a personal profile of the user based on the accessed information, (5) evaluate the personal profile using a concept graph relating a plurality of key words and concepts to one another, (6) evaluate the personal profile of the using statistical methods and algorithms applied to the user's personal information, including information about his friends, associate and contacts, and/or (7) determine an interest and/or characteristic of the user based on the evaluation. The interface may be communicatively coupled to the processor and configured to enable the processor to communicate with at least one of the user and the third party via a communication network. The communication network may be configured to enable the processor to communicate with at least one of the user and the third party via the interface. The user interest and/or characteristic determined through this process may be provided to a third party directly in the form of an interest and/or characteristic, in the form of a probability of a user having an interest and/or characteristic, and/or in the form of a recommendation (such as for a product, content, service and/or price), and the entire process or any component thereof can be enhanced through a machine learning component.

### BRIEF DESCRIPTION OF THE DRAWINGS

The present application is illustrated by way of example, and not limitation, in the figures of the accompanying drawings, in which:

FIG. 1A is a block diagram illustrating an exemplary system for determining a user interest and/or characteristic, in accordance with some embodiments of the present invention;

FIG. 1B is a block diagram illustrating exemplary components included within a computer system, in accordance with some embodiments of the present invention;

FIGS. 1C and 1D are block diagrams illustrating exemplary personalization systems, in accordance with some embodiments of the present invention;

FIG. 2A illustrates an exemplary concept graph, in accordance with some embodiments of the present invention;

FIG. 2B illustrates an exemplary personal interest graph, in accordance with some embodiments of the present invention;

FIGS. 3-5 are flow charts depicting exemplary processes, in accordance with some embodiments of the present invention; and

FIGS. 6-12B are screen shots of various user interfaces displayed to the user that enable the user to interact with systems and system components described herein, in accordance with some embodiments of the present invention.

Throughout the drawings, the same reference numerals and characters, unless otherwise stated, are used to denote like features, elements, components, or portions of the illustrated embodiments. Moreover, while the subject invention will now be described in detail with reference to the drawings, the description is done in connection with the illustrative embodiments. It is intended that changes and modifications can be made to the described embodiments without departing from the true scope and spirit of the subject invention as defined by the appended claims.

### Written Description

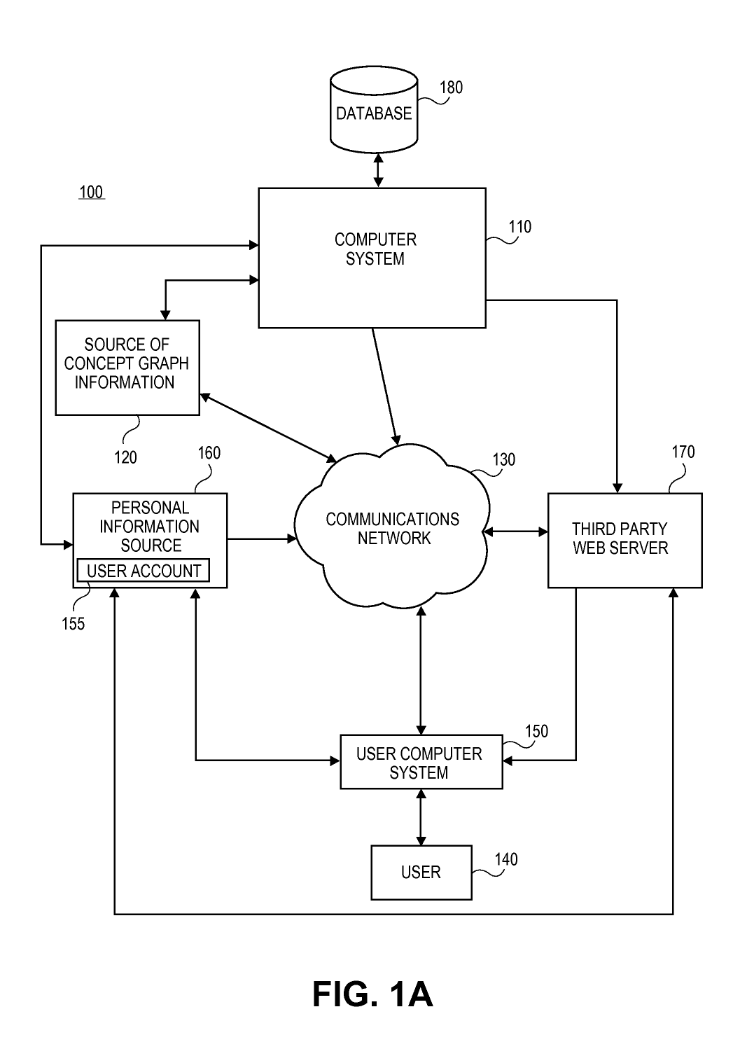

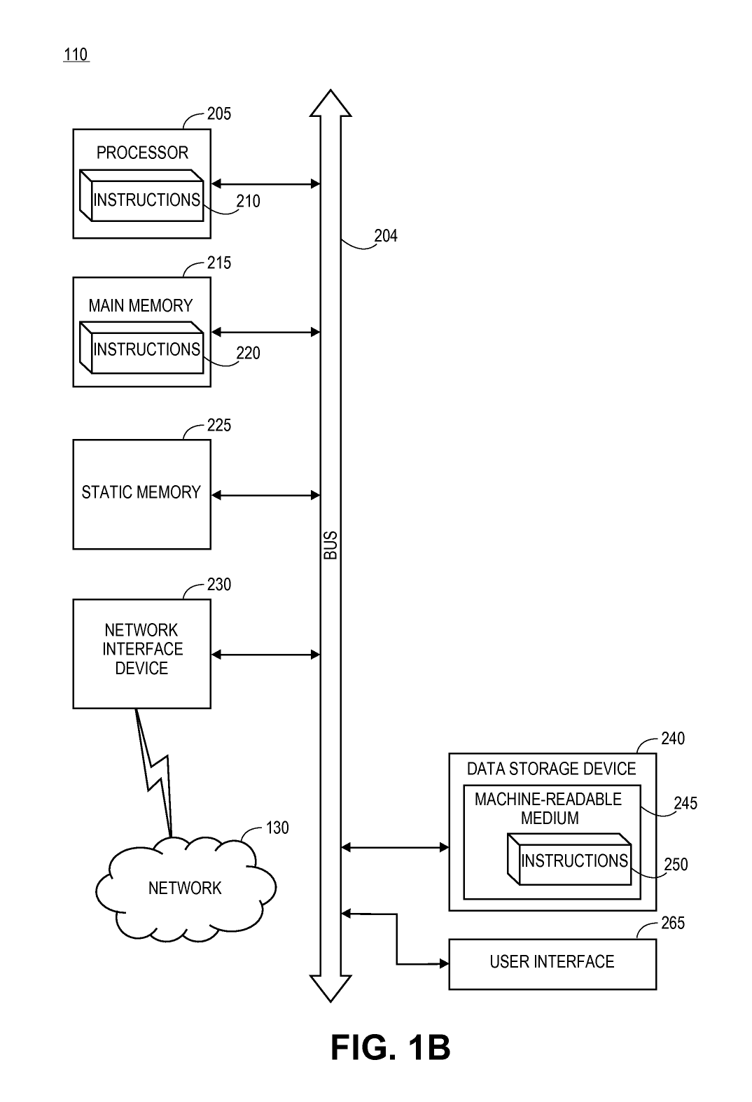

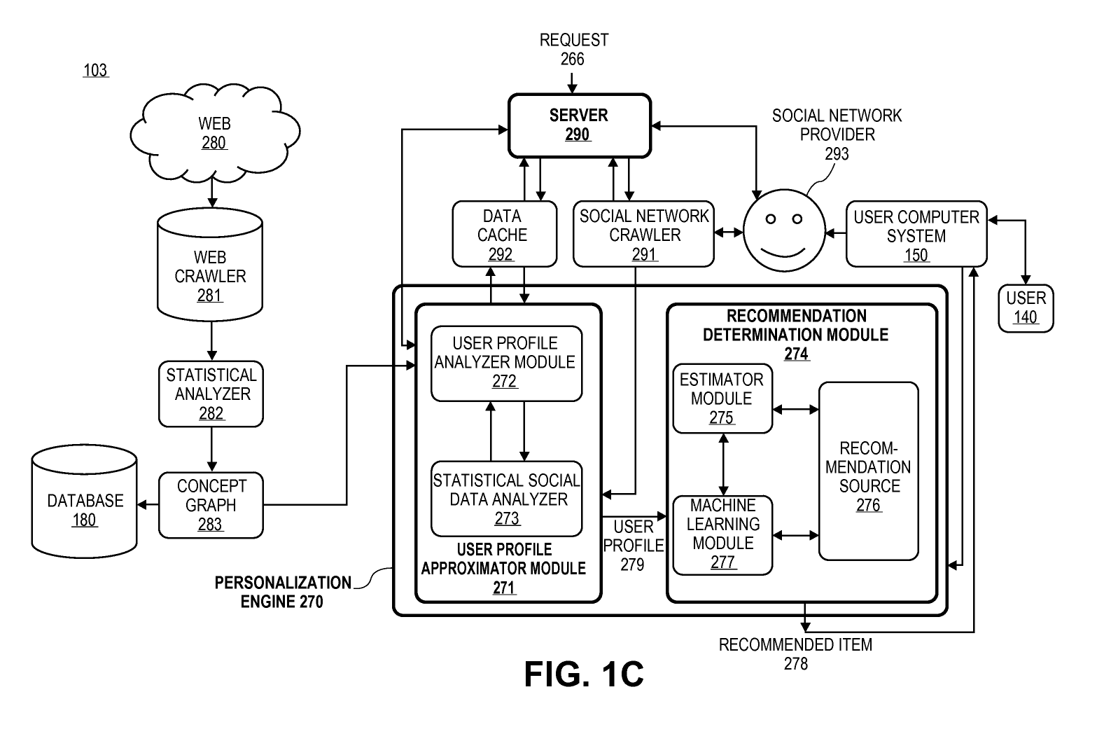

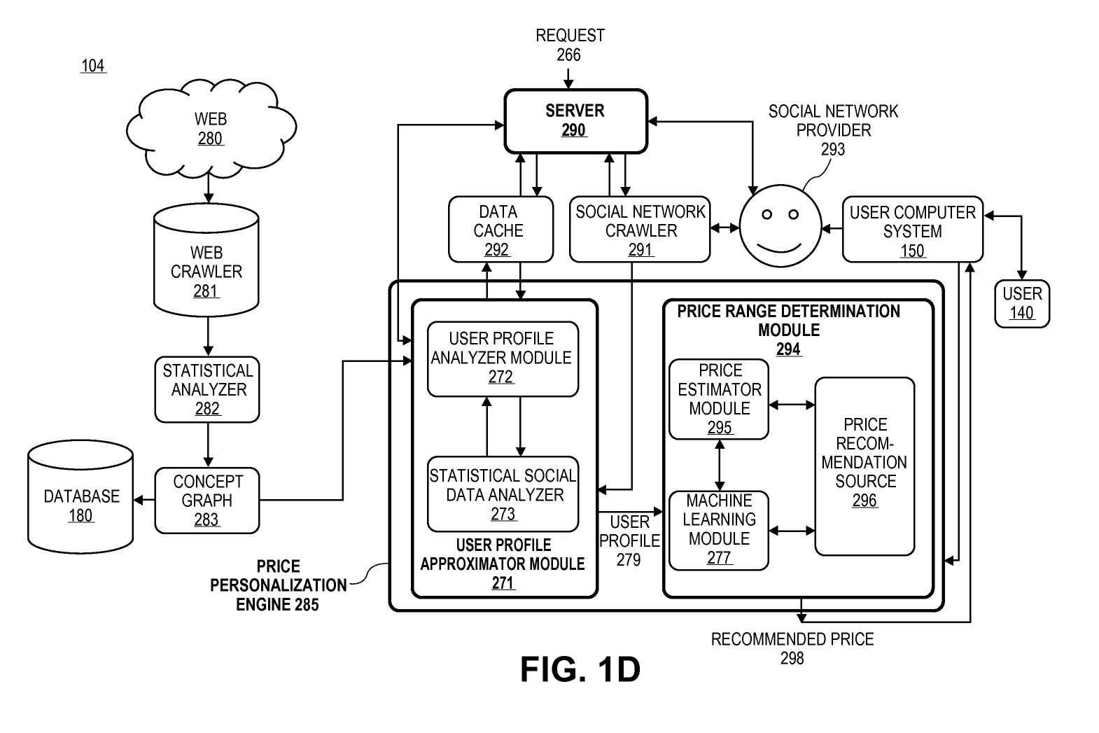

Referring to FIG. 1A, an example of a system 100 including elements thereof configured to determine a user interest and/or characteristic is depicted. A user 140 interacts with system 100 via user computer system 150, which is communicatively coupled to a computer system 110 via a communications network 130. In some embodiments, user 140 may be, for example, a visitor to a web site that interacts with system 100 and/or components therein using, for example, a different user 140's credentials. Computer system 110 may be any computer system enabled to generate a concept graph, a user interest and/or characteristic graph, and/or determine an interest and/or characteristic associated with a user 140 via any of the processes disclosed herein. Although only one computer system 110 is illustrated, it should be appreciated that this one computer system may represent many computer systems, arranged in a central or distributed fashion, for example, such computer systems may be organized as a central cloud and/or may be distributed geographically or logically to edges of a system such as a content delivery network or other arrangement.

User computer system 150 may be any computer system configured to enable user 140 to communicate with any of the components of system 100 via either a direct communicative coupling with said component and/or a communicative coupling with said component via a communications network 130 using, for example, a wired or wireless connection to a modem or similar equipment that couples user computer system 150 to communications network 130 in order to exchange data therewith, and, in turn, delivers data to user computer system 150 from computer system 110. Exemplary user computer systems 150 include a personal computer (PC), a tablet computer (e.g., an iPad™), a mobile communication device (e.g., a BlackBerry™ or iPhone™), and/or a portable computer system (e.g., a laptop computer). Communications network 130 may be any network enabling communication between any of the components included within system 100, such as the Internet, a local area network (LAN), a wireless local area network (WLAN), and/or any other appropriate network.

Source of concept graph information 120 may be any source of information suitable for use in generation of a concept graph. Exemplary sources of concept graph information 120 include Web sites (e.g., Wikipedia.org, Yahoo.com, or Answers.com) commercial entities (e.g., retail sales enterprises or news reporting enterprises) governmental agencies (e.g., National Oceanic and Atmospheric Association (NOAA) or Environmental Protection Agency (EPA)), publicly available databases (e.g., the Patent Database provided by the United States Patent and Trademark Office), and subscription based databases (e.g., the Institute of Electrical and Electronics Engineers, Inc. (IEEE) Standards Service Database or the Natural Medicines Comprehensive Database).

Personal information source 160 may be any source of information enabled to store, maintain, and/or access a user account 155 generated and/or maintained directly and/or indirectly by user 140 via, for example, user computer system 150. Exemplary personal information sources 160 include social networking and media platforms (e.g., Facebook™, Twitter™, or LinkedIn™), retail enterprises (e.g., Amazon™ or Netflix™), financial platforms (e.g., banks or credit card agencies), and email service providers (e.g., Gmail™ or Hotmail™). User account 155 may include information specific to user 140 that is, for example, directly or indirectly entered or uploaded to user account 155 (e.g., photographs, text, endorsements, associations, purchases) and/or information that is passively observed (e.g., Web site browsing history or online purchasing history).

Third party Web server 170 may be any Web server enabled to provide a webpage to a user. Exemplary third party Web servers 170 may be operated by, for example, search engines, retail enterprises, online encyclopedias, and sources of audio, visual, and/or textual content.

Optionally, a database 180 may be communicatively coupled to computer system 110. Database 180 may be any data storage device, combination of data storage devices, and/or data store enabled to store a portion of a generated concept graph and/or data associated with, for example, user 140. On some occasions, data may be automatically deleted from database 180 upon the expiration of a predetermined time period (e.g., an hour, a day, a week, or a month).

FIG. 1B is a block diagram illustrating one example of a computer system 110 within which a set of instructions 210, 220, and 250 for causing computer system 110 to perform any one or more of the methodologies discussed herein may be executed. In this example, components of computer system 110 are coupled directly, or indirectly, to a communication bus 204, although in other cases layers of busses or, indeed, different busses or other communication paths may be used to communicatively couple the various components of this device. Therefore, it should be appreciated that the example shown in FIG. 1B is intended only as one possible computer system configuration and is not intended to limit the scope of the present invention in any way.

In alternative embodiments, computer system 110 operates as a standalone device or may be connected (e.g., communications network 130) to other machines. In a network deployment, computer system 110 may operate in the capacity of a client machine in a server-client network environment, or as a peer machine in a peer-to-peer (or distributed) network environment.

Computer system 110 includes a network interface device 230 coupled to bus 204. Network interface device 230 provides a two-way data communication path with computer system 110. For example, network interface device 230 may be a wired or wireless local area network (LAN) interface to provide a data communication connection to a compatible LAN (such as a LAN that uses an IEEE 802.11a/b/g/n communication protocol). Computer system 110 can send messages and receive data, sets of instructions, and/or content elements through network interface device 230. A user of computer system 110 may communicate with computer system 110 via user interface 265. Exemplary user interfaces 265 include a keyboard, mouse, and microphone.

Computer system 110 also includes a processor 205 (e.g., a central processing unit (CPU), a graphics processing unit (GPU), or both), a main memory 215 (e.g., read-only memory (ROM), flash memory, dynamic random access memory (DRAM) such as synchronous DRAM (SDRAM) or Rambus DRAM (RDRAM), etc.), and a static memory 225 (e.g., flash memory, static random access memory (SRAM), etc.), which communicate with each other via a bus 204 or other communication mechanism for communicating information.

Computer system 110 may further include a data storage device 240 and RAM 215 for storing, for example, a concept graph, personal information about a user, such as user 140, and/or a user interest and/or characteristic graph. Data storage device 240 may include a non-transitory machine-readable storage medium 245 on which is stored one or more sets of instructions 250 (e.g., software) embodying any one or more of the methodologies or functions described herein. Set of instructions 250 as well as the concept graph, personal information about a user, such as user 140, and/or a user interest and/or characteristic graph may also reside, completely or partially, within main memory 215 and/or within processor 205 during execution of various operations by computer system 110. In some embodiments, static memory 225 and processor 205 may also constitute non-transitory machine-readable storage media (at least in part). In some cases, set of instructions 250 may be transmitted or received over a communications network 130 via network interface device 230 as, for example, a software application or an update to a software application. In alternative embodiments, hard-wired circuitry may be used in place of, or in combination with, set of instructions 250 to implement the invention. Thus, embodiments of the invention are not limited to any specific combination of hardware circuitry and software.

While set of instructions 250 are shown in an exemplary embodiment to be on a single medium, the term “non-transitory machine-readable storage medium” should be taken to include a single medium or multiple media (e.g., a centralized or distributed database or data source and/or associated caches and servers) that store the one or more sets of instructions 250. The term “non-transitory machine-readable storage medium” shall also be taken to include any non-transitory medium that is capable of storing, encoding, or carrying a set of instructions for execution by computer system 110 and that cause computer system 110 to perform any one or more of the methodologies of the present invention. The term “non-transitory machine-readable storage medium” shall accordingly be taken to include, but not be limited to, solid-state memories, optical media, and magnetic media.

FIG. 1C is a block diagram of a system 103 for generating an output of a recommendation to a particular user, such as user 140. Although the components of system 103 are depicted as being directly communicatively coupled to one another, this is not necessarily the case. For example, one or more of the components of system 103 may be communicatively coupled via a distributed computing system, a cloud computing system, or a networked computer system communicating via the Internet.

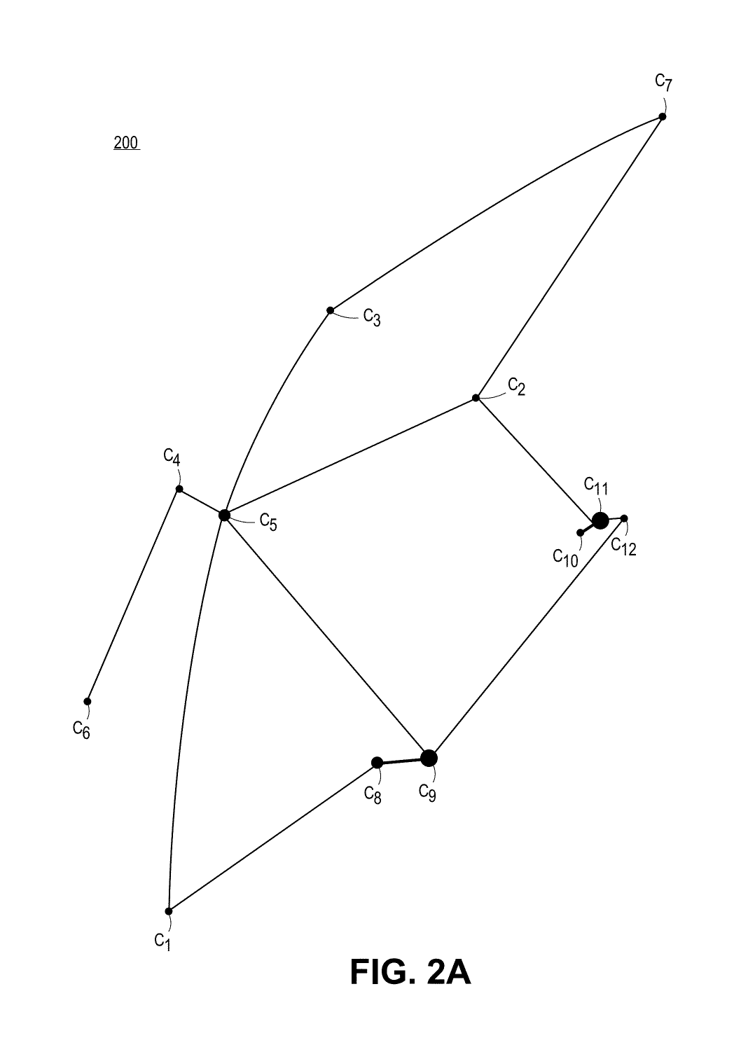

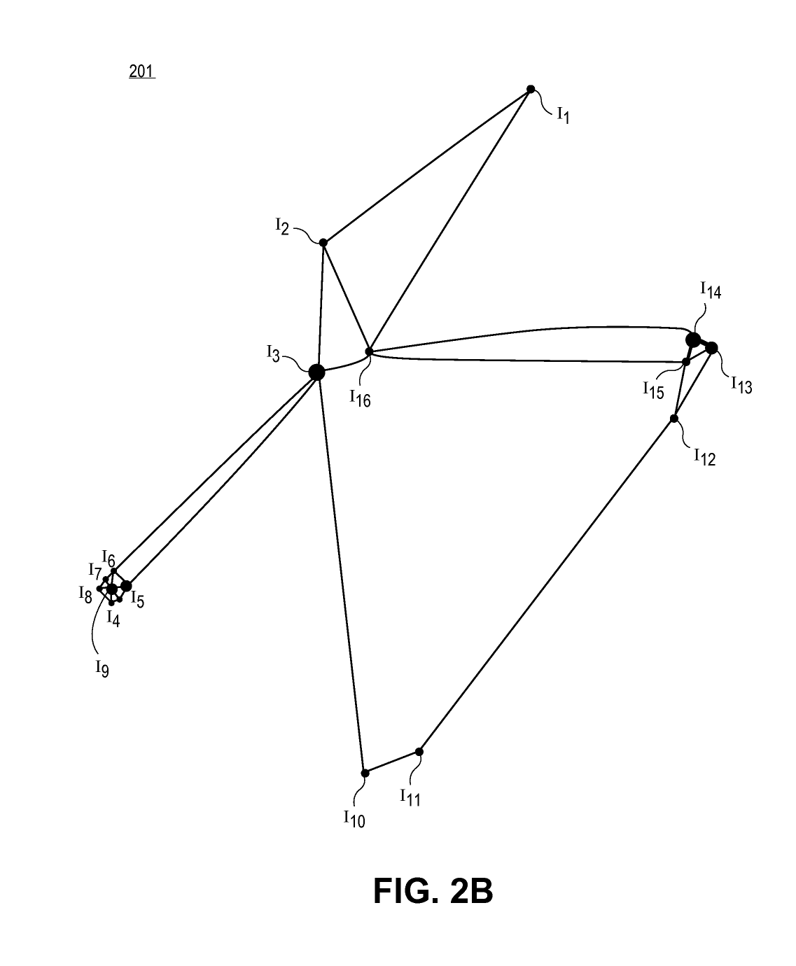

System 103 includes a Web crawler 281 that is communicatively coupled to the World Wide Web 280 (commonly referred to as “the Web”) and operates to browse the Web 280 to gather up-to-date data from multiple data sources, such as a third party Web server like third party Web server 170 and/or a concept graph information source like source of concept graph information 120 that are are communicatively coupled to the Web 280. On some occasions, the Web 280 and/or Web crawler 281 may be resident in and/or communicatively coupled to communications network 130 and/or source of concept graph information 120. A statistical analyzer module 282 is configured to run statistical analysis on the data contents of the Web 280 received from the Web crawler 281 to create a concept graph 283 (also referred to as “semantic graph,” “knowledge graph,” or “concept relationship graph”). On some occasions, statistical analyzer module 282 may be resident in computer system 110 and the created concept graph 283 may be stored in a database such as database 180. Further details regarding the creation of concept graph 283 are provided below with regard to FIGS. 2A-5.

When a server 290 receives a request 266 for information regarding a user, such as user 140, from, for example, a third-party Web server, such as third-party Web server 170, server 290 and may request information from the user from, for example, a data cache 292 and/or a social network crawler 291. Data cache 292 may store information associated with the user for a limited duration of time, such as 1 hour, 2 days, or a month, with the duration dependent on the type of application. Social network crawler 291 may then communicate with a social network provider 293 (e.g., Facebook™, Google+™, or LinkedIn™) to obtain up-to-date data associated with the user. Server 290 may also communicate with data cache 292 to retrieve data associated with the user stored therein when such data is available. Server 290, data cache 292, and/or social network crawler 291 may then communicate data associated with the user to personalization engine 270 and its component parts.

User profile approximator module 271, user profile analyzer module 272, and/or statistical social data analyzer 273 may then analyze the received data in order to determine, for example an interest and/or characteristic associated with the user. The user profile analyzer module 272 can operate separately, in parallel, or collectively with the statistical social data analyzer 273 and performs its analysis using concept graph 283. Statistical social data analyzer 273 may be configured to analyze data associated with, but not necessarily directly connected to, the user, such as data associated with the particular user's friends, contacts, associates, or preferences not directly associated with the particular user, in order to estimate a probability that a particular interest or characterisitc is associated with the user. Such information may include, for example, the age of the user's friends, a profession associated with one or more of the user's contacts, or a location associated with a restaurant the user prefers or has visited.

The user profile approximator module 271 is configured to receive data, including, but not limited to, data from the social network crawler 291 and the concept graph 283, to create an approximate user profile using applicable probability distribution models and algorithms to deduce features about the user or determine a probability that a particular characteristic or interest is associated with the user, even when the user has not explicitly declared the characteristic or interest in his/her social network information as received from data cache 292 and/or social network crawler 291. Exemplary deductions or probable characteristics include a user's interests (such as her favorite sport, genre of music or food), preferences, and demographic information (such as her gender, level of education, age, affluence, and family status). For example, user profile approximator module 271 may deduce a user's age based on the user's friends' social data and interest preferences by, for example, applying concept graph 283 to the received user data. Output from user profile approximator module 271, user profile analyzer module 272 and/or statistical social data analyzer 273 may be characterized as a user profile 279 and may be sent, for example, separately, in parallel, or collectively to the recommendation determination module 274.

Recommendation determination module 274 may be configured to generate one or more recommendations for the user. A recommendation may be, for example, a product, media content, a service, a social contact, an employment opportunity, an action to be taken, and/or an advertisement to be presented to the user. An exemplary configuration of recommendation determination module 274 is that of a machine-learning loop including a recommendation estimator module 275, a recommendation source 276, and a machine-learning module 277 as shown in FIG. 1C. However, a more simplified or more complex method for implementing the recommendation determination module 274 is possible without departing from the spirit and scope of the present invention.

Recommendation estimator module 275 may be configured to select one or more recommendations from recommendation source 276 based upon, for example, analysis of user profile 279 and may, for example, select a recommendation that matches one or more characteristics or interests of the user as indicated in user profile 279. Exemplary recommendation sources 276 include third-party Web servers, such as third-party Web server 170 or an advertisement server.

The selected recommended item 278 may then be provided to the user via, for example, user computer system 150. In some embodiments, the user's interaction with or response to the recommendation (e.g., affirmation or denial of the recommendation) may be provided to personalization engine 270 and/or, more specifically, to recommendation determination module 274 and machine learning module 277. Machine learning module 277 may be configured to learn, over time, the user's pattern of behavior in response to the recommendations and may use such learning to improve future recommendations provided to the user. On some occasions, machine-learning module 277 may also use patterns of behavior from other users to improve recommendations provided to the user.

FIG. 1D is a block diagram of a system 104 like system 103 specifically adapted for the purpose of providing a personalized price recommendation to the user for purchasing a particular product or service. Many of the components of system 104 are similar to those of system 103 with the exception that system 104 does not include a recommendation determination module 274, a recommendation estimator module 275, and a recommendation source 276. Instead, system 104 includes a price range determination module 294 that includes a price estimator module 295, a pricing information recommendation source 296, and machine-learning module 277. Additionally, system 104 implements a specialized price personalization engine 285 configured to generate a personalized price for a user, such as user 140. Price range determination module 294 may determine a price and/or price range recommendation(s) 298 for an offer to purchase, for example, a product or service that are personalized to the user.

Similar to system 103, the user profile approximator module 271 in system 104 is configured to receive data, including, but not limited to, data from the social network crawler 291 and the concept graph 283, to create an approximate user profile using applicable probability distribution models and algorithms to deduce features about the user or determine a probability that a particular characteristic or interest is associated with the user, even when the user has not explicitly declared the characteristic or interest in his/her social network information as received from data cache 292 and/or social network crawler 291. Exemplary deductions or probable characteristics include a user's interests, preferences (such as her preference for a Rolex watch over Timex) and demographic information (such as her gender, level of education, age, affluence, and marital status). For example, user profile approximator module 271 may deduce a user's affluence based on the user's friends' social data and interest preferences by, for example, applying probabilistic models and/or applicable algorithms to such data. Output from user profile approximator module 271, user profile analyzer module 272 and/or statistical social data analyzer 273 may be characterized as a user profile 279 and may be sent, for example, separately, in parallel, or collectively to the price range determination module 294.

Price range determination module 294 may be configured to determine one or more price and/or price range recommendations for an offer to purchase, for example, a product or service, wherein the price and/or price range is personalized to the user. On some occasions, price range determination module 294 may be further configured to estimate an offer price for a product or service that maximizes the probability that the user will accept the offer price and purchase the associated product or service. Price recommendation estimator module 295 may be configured to select one or more pricing recommendations from price recommendation source 296 based upon, for example, analysis of user profile 279 and may, for example select a recommendation that matches one or more characteristics or interests of the user as indicated in user profile 279. Exemplary price recommendation sources 296 include third-party Web servers, such as third-party Web server 170 and an advertisement server.

The selected recommended price 298 may then be provided to the user via, for example, user computer system 150. In some embodiments, the user's response to the price recommendation (e.g., affirmation or denial of the recommendation) may be provided to price personalization engine 285 and, more specifically, to price range determination module 294 and machine learning module 277. Machine learning module 277 may be configured to learn, over time, the user's pattern of behavior in response to the recommendations and may use such learning to improve future recommendations provided to the user and/or other users. On some occasions, machine learning module 277 may also use patterns of behavior from other users to improve recommendations provided to the user.

FIG. 2A depicts a simplified concept graph 200 illustrating connections between concepts, or nodes, C₁₋₁₂. In some embodiments, concept graph 200 may include, for example, hundreds, millions, or even billions of concepts or nodes.

Concept graph 200 may be generated by, for example, computer system 110 using information received from, for example, one or more sources of concept graph information 120. Concepts depicted in concept graph 200 may represent, for example, words, terms, multi-word phrases, nouns, adjectives, locations, interests, and/or words. The proximity of one concept to another as depicted on the concept graph may indicate a degree of similarity or association between the two concepts.

On some occasions, the proximity of one concept to another may be calculated according to one or more criterion. Such criterion may include, for example, the link structure of pages that are related to concepts or the frequency of co-occurring mentions of the concepts in a text. In some instances, the relative importance of a concept may also be calculated based on the link structure of the graph.

FIG. 2B depicts an exemplary simplified personal interest and/or characteristic graph 201 illustrating connections between interest and/or characteristics associated with the user, or nodes, I₁₋₁₅. In some embodiments, personal interest and/or characteristic graph 201 may include, the for example, hundreds, thousands, or even millions of interests and/or characteristics. Although personal interest and/or characteristic graph 201 is depicted in two-dimensional form, the graph may also be in a three-dimensional form.

Personal interest and/or characteristic graph 201 may be generated by, for example, computer system 110 using information received from, for example, user account 155 when evaluated using information included in a concept graph, such as concept graph 200. Interests and/or characteristics depicted in personal interest and/or characteristic graph 201 may represent, for example, words, terms, multi-word phrases, nouns, adjectives, locations, interests, and/or words. The proximity of one interest and/or characteristic to another as depicted on user interest and/or characteristic graph may indicate a degree of similarity or association between the two interests and/or characteristics. Likewise, the length of a line connecting two interests and/or characteristics may indicate a degree of similarity or association between the two interests and/or characteristics.

On some occasions, the proximity of one interest and/or characteristic to another may be calculated according to one or more criterion. Such criteria may include, for example, the link structure of pages that are related to concepts or interests and/or characteristics. In some instances, the relative importance of an interest and/or characteristic may also be calculated based on the link structure of the interest and/or characteristic graph.

On some occasions, a user's personal interest and/or characteristic graph profile may be generated in the form of a table, like Table 1, listing scores, or values, for various interests and/or characteristics generated from the personal information of, for example, user account 155. In one embodiment, a relatively high score for a particular interest and/or characteristic may indicate a user's a strong preference for that interest and/or characteristic. Likewise, a relatively low score for a particular interest and/or characteristic may indicate a user's weak preference for that interest and/or characteristic. This scoring can be seen in Table 1 below, wherein the user's strong preference for and interest in San Francisco is indicated with a relatively high score (i.e., 2.6810) and her relatively weaker interest in Wimbledon is indicated by a relatively lower score (i.e., 1.4469).

TABLE 1

| Interest and/or | |
|---|---|
| Characteristic | Score |
| San Francisco | 2.6810 |
| Tennis | 2.6771 |
| Basketball | 2.5991 |
| Skiing | 2.4052 |
| European travel | 2.1263 |
| Andre Agassi | 2.0965 |
| Starbucks | 1.4659 |
| Wimbledon | 1.4469 |
| Expedia | 1.1695 |

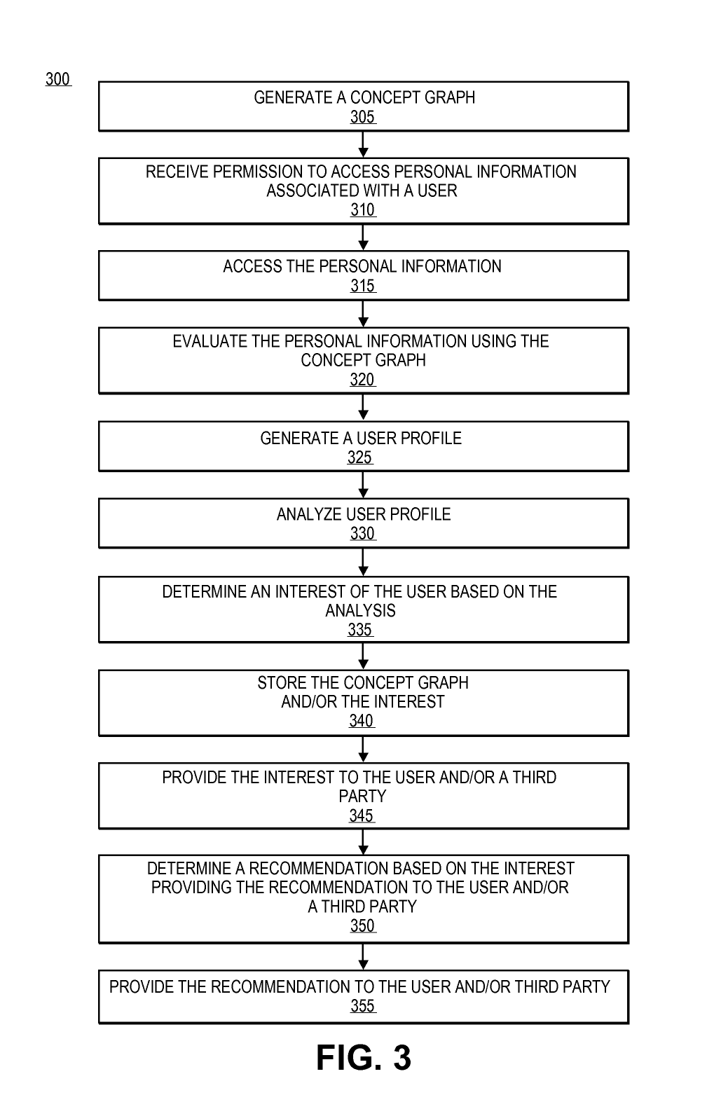

FIG. 3 depicts an exemplary process 300 for determining a user interest and/or characteristic. Process 300 may be executed by, for example, any of the systems and/or system components described herein. On some occasions, process 300 may be executed using a previously generated concept graph. Such a concept graph may be generated by, for example, a component of system 100, such as computer system 110, and stored in a database, such as database 180.

On other occasions, process 300 may include generating a concept graph, as in step 305. In one embodiment, generating a concept graph may include accessing a source of information, such as source of concept graph information 120, and retrieving and/or downloading the information. The information may then be processed and analyzed to determine relationships between, for example, words, phrases, terms, and concepts included therein and a concept graph, like concept graph 200, may be generated indicating relationships between the words and/or concepts. On some occasions, relationship indications may be weighted to, for example, indicate the strength of the relationship between the words and/or concepts.

Whether the concept graph is generated in step 305 or not, permission to access personal information associated with the user may be received in step 310. This permission may be received, for example, directly from the user via, for example, a user computer system, such as user computer system 150. Permission to access personal information associated with the user may also be received indirectly from, for example, a third-party, such as third-party Web server 170. For example, a user interfacing with third party Web server 170 may wish to execute a transaction using personal information associated with the user's account at an entity other than the entity associated with third-party Web server 170, such as user account 155.

In some embodiments, permission to access personal information associated with the user may be received from someone other than the user, such as a visitor to a website, who is not the user but provides permission to access the personal information associated with the user via, for example, providing the user's (and not the visitor's) login credentials to log into a website or account associated with the user.

Once permission is received, at step 315, the personal information included in the user account may be accessed and evaluated using the concept graph (step 320). At step 325, user profile analyzer module 272 is configured to receive the concept graph data and generate a user profile, which in some cases may be similar to the user profile of Table 1 and/or user profile 279. At step 330, the user profile may be analyzed and a specific interest and/or characteristic of the user may be determined at step 335. On some occasions, multiple interests and/or characteristics of a user may be determined. Optionally, the interest and/or characteristic graph and/or concept graph may be stored in, for example, database 180.

Execution of step 320 may include using the concept graph to determine relationships between words and concepts included in the accessed personal information. In this process, interests, characteristics, words, and/or concepts related to those included in the accessed personal information, but not explicitly provided in the accessed personal information, may be determined. Thus, the interests and/or characteristics determined by process 300 provide a richer understanding of the user than a direct, literal analysis of the accessed personal information. For example, a user's personal information may include a list of names that are not directly related to one another. However, evaluating the list of names using the concept graph may indicate one or more underlying, but not explicitly stated, relationships, concepts, characteristics, or interests that relate the names included on the list to one another. These relationships, concepts, characteristics, or interests are then determined to be interests and/or characteristics associated with the user. To further illustrate the example, suppose that the list of names includes Andre Agassi, Arthur Ashe, John Bromwich, and Igor Andreev. While the literal words of the names included in the list share no obvious relationship, when evaluated using the concept graph, the interest and/or characteristic of championship male tennis player is determined because each of these names is associated with a championship male tennis player.

On some occasions, the determined interest and/or characteristic, user profile, and/or concept graph may be stored in, for example, database 180 (step 340). In some embodiments, the determined interest and/or characteristic may be provided to, for example, the user and/or a third party, such as third party Web server 170 (step 345). On some occasions, the determined interest and/or characteristic may be provided in response to a request, while on other occasions, it may be provided as an unsolicited notification. For example, a list of users with interests and/or characteristics related to tennis may be provided to a retailer of tennis equipment.

Optionally, the evaluation and/or determined interest or characteristic may be used to determine a price or range of prices the user may be willing to pay for a particular good or service. For example, a user with a strong interest in skiing may be willing to pay a higher price for a holiday ski weekend than a user with a relatively weaker, or nonexistent, interest in skiing.

In some embodiments, the interest and/or characteristic may be used to determine a recommendation at step 350 and the recommendation may be provided to, for example, the user and/or a third party, such as third party Web server 170 at step 355. Continuing the above-cited example, a recommendation for hotel accommodations near Wimbledon may be provided to a user two months prior to the men's tennis championship tournament there. A recommendation may also be provided to a travel service or ad placement service recommending that an ad related to tennis be displayed to the user while he or she is viewing a Web page associated with the travel service.

In some embodiments, a user's interaction with recommendations may be observed and used to, for example, update a user's interest and/or characteristic graph and/or target future recommendations to the user. Additionally, or alternatively, the user's interactions with, for example, the user account and/or a website may be analyzed and the concept graph and/or user interest and/or characteristic profile may be updated responsively to the analysis.

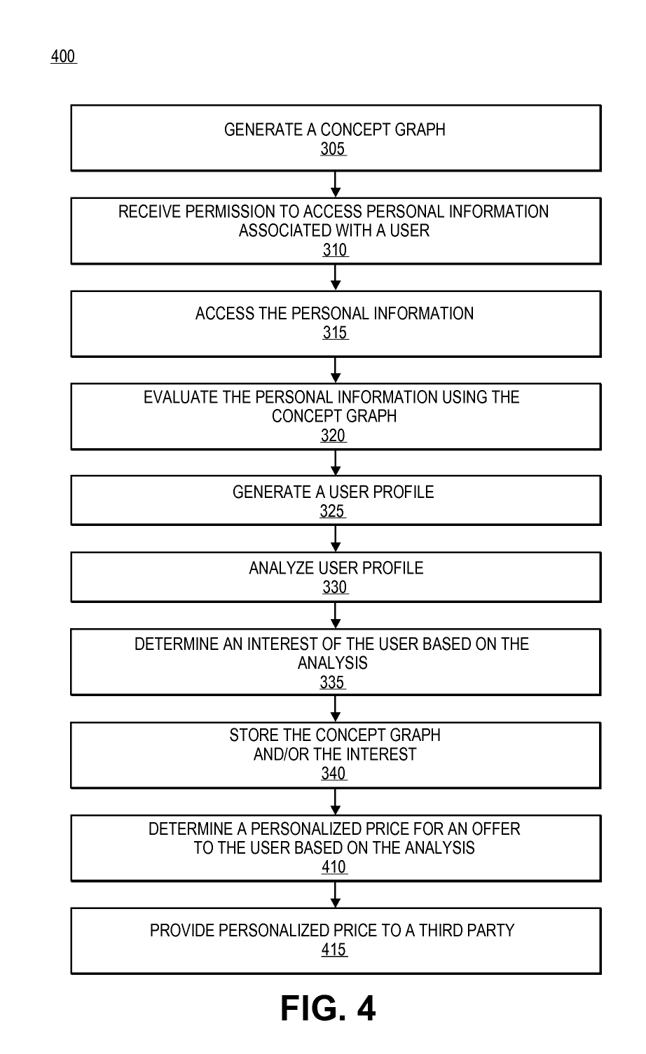

FIG. 4 is a flowchart illustrating a process 400 for determining a personalized price for an offer directed to the user. Process 400 may be executed by, for example, any of the systems and/or system components described herein.

In process 400, one or more of the first eight steps of process 300 (steps 305-340) may be executed. Then, a personalized price for an offer directed toward the user may be determined responsively to the analysis (step 410) and the personalized price may be provided to a third party (step 415). In some embodiments, a price may be personalized by varying the level or amount of discount offered to a particular user based upon, for example, the analysis. Continuing the example cited above, the number of interests and/or characteristics related to tennis and/or the strength of those interests and/or characteristics may be used to determine what price, or range of prices, the user might pay for an offer related to tennis. Other interests, characteristics, or personal information associated with the user may also be used to determine a personalized price. For example, if photographs included in the personal information of a first user indicate that he or she prefers to stay in luxury hotels, a recommendation of a minimal price discount for a luxury hotel room may be provided to a third party (e.g., Web server associated with a travel service) catering to said user. In contrast, if photographs included in the personal information of a second user indicate that he or she does not prefer to stay in luxury hotels, a recommendation of a relatively greater discount for the same luxury hotel room may be provided to the third party/travel service. Alternatively, or additionally, discounts may be offered to a user based on a characteristic of the user determined by the analysis, such as her student or senior citizen status.

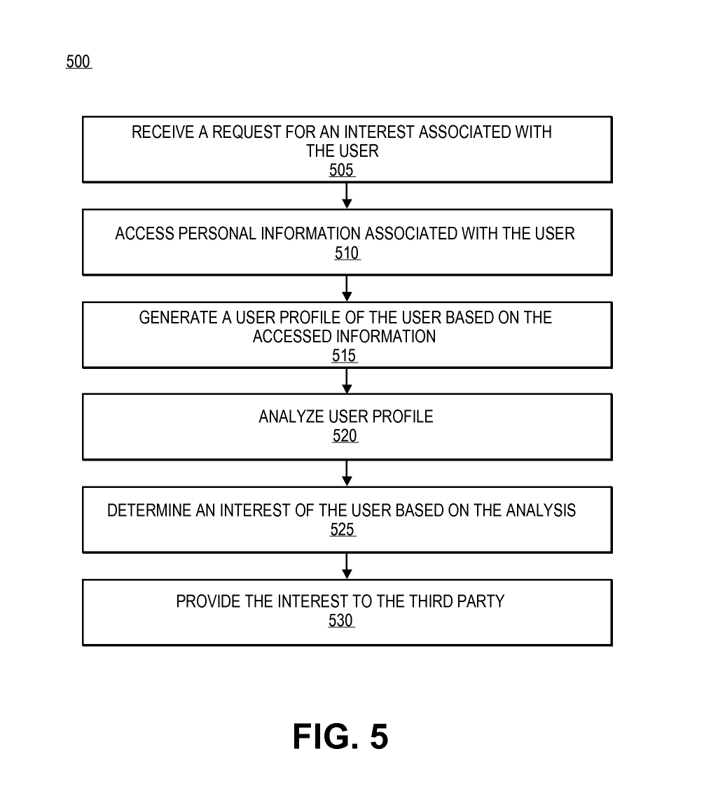

FIG. 5 depicts an exemplary process 500 for determining a user interest and/or characteristic. Process 500 may be executed by, for example, any of the systems and/or system components described herein.

In step 505, a request for an interest and/or characteristic associated with a user may be received from a third party, such as third-party Web server 170. The request may include permission to access personal information associated with the user stored in, for example, a user account, such as user account 155. Then, the personal information associated with the user may be accessed (step 510) and a user profile may be generated based on the accessed information (step 515). The user profile may then be analyzed (step 520) and an interest and/or characteristic of the user may then be determined based upon the evaluation (step 525) and the interest and/or characteristic may be provided to the requesting third-party (step 530).

The following is an example of how process 500 may be executed. A request for an interest and/or characteristic associated with a user, such as user 140, interacting with, for example, a third-party Web server, such as third-party Web server 170, may be received from the third-party Web server. For ease of discussion, suppose that the user is interacting with the Web server of an online retailer and is engaged in browsing for cookbooks. The third-party Web server may request an interest and/or characteristic of the user in order to, for example, provide targeted advertising to the user, provide a personalized offer for the purchase of a product or service to the user, and/or provide a topic of interest to the user. For example, if a determined interest and/or characteristic of the user is French culture, the online retailer may provide recommendations relating to cookbooks focusing on French cuisine even when the user is browsing for cookbooks focused on Chinese cuisine. Likewise, if the determined interest and/or characteristic of the user is European travel, the online retailer may provide, or request from an ad service, an advertisement for display to the user of discounted airline flights to France and Belgium. If a further interest and/or characteristic of the user indicates that the user has one or more school-aged children, the online retailer may provide, or request from an ad service, an advertisement for display to the user offering a special family discount on airline flights to France and Belgium during times of the year when school age children are known to be off from school (e.g., spring break or summer recess). Further, if an analysis of user profile or a user's social graph data—such as their brand affinities, friends' demographics, and/or other relevant data—results in a determined characteristic of the user that indicates their socio-economic status (or affluence), a more or less expensive item, or more or less steeply discounted offer for an item, may be made to the user, as appropriate, based upon her price sensitivity. Myriad other use cases can be configured using the processes described herein.

On some occasions, demographic data, socio-graphic data, and/or self assertions regarding the status of a user (e.g., whether a user is a student, over 21 years of age, a senior citizen, etc.), among other data, may be determined and/or validated via analysis of the personal information associated with the user according to any of the processes described herein. For example, when a user asserts he or she is a college student, his or her personal data may be analyzed to determine whether the personal data is consistent with personal data typically associated with college students (e.g., age of one's friends, an analysis of the age of other users with whom one has interacted, taste for popular culture, or photo tags). Additionally, or alternatively, in some instances, a degree of reliability for the determination and/or validation may also be determined via analysis of the personal information associated with the user according to any of the processes described herein.

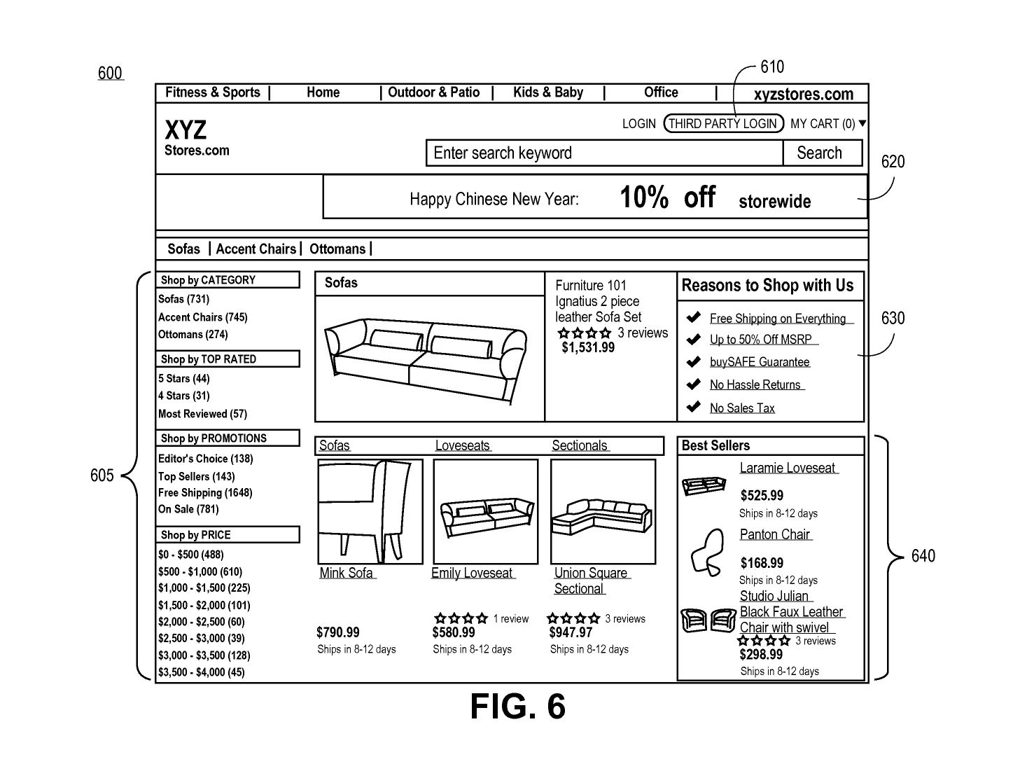

FIGS. 6-12B illustrate various user interfaces displayed on a user computer system, such as user computer system 150, that enable a user to, for example, interact with one or more components of system 100 and/or execute one or more processes as disclosed herein.

Turning now to FIG. 6, user interface 600 depicts an exemplary Web page provided to a user computer system, such as user computer system 150, by, for example, a third party Web server, such as, for example, third party Web server 170. User interface 600 may include, for example, a product list 605 including, for example, a list of product categories and products available for sale by an entity associated with the third party Web server. User interface 600 may also include a recommendation list 640, an online coupon 620, and/or a list of advertisements 630. List of sponsored ads 630, recommendation list 640 and/or online coupon 620 may be selected for display on user interface 600 via any conventionally available means (e.g., ad server or the third party Web server, etc.).

User interface 600 may also include a third party login button 610. Selection of (clicking on) third party login button 610 by a user via the user computer system may enable the user to use identifying information and/or credentials associated with a user account, such as user account 155, to create a new account in, or login into an account on, and/or otherwise access information associated with the business or entity associated with the third party Web server without entering any additional information.

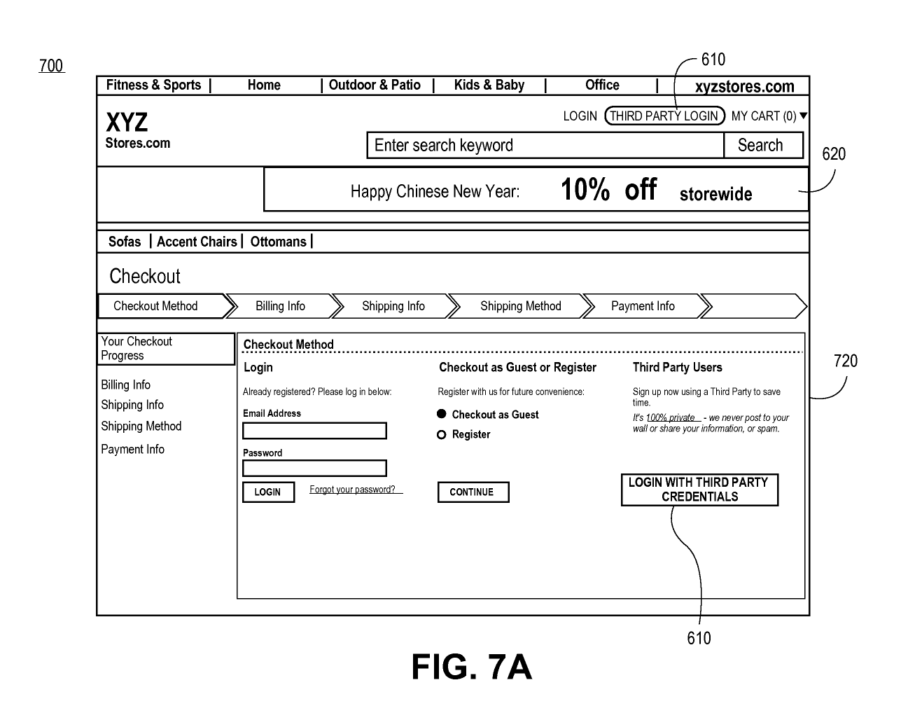

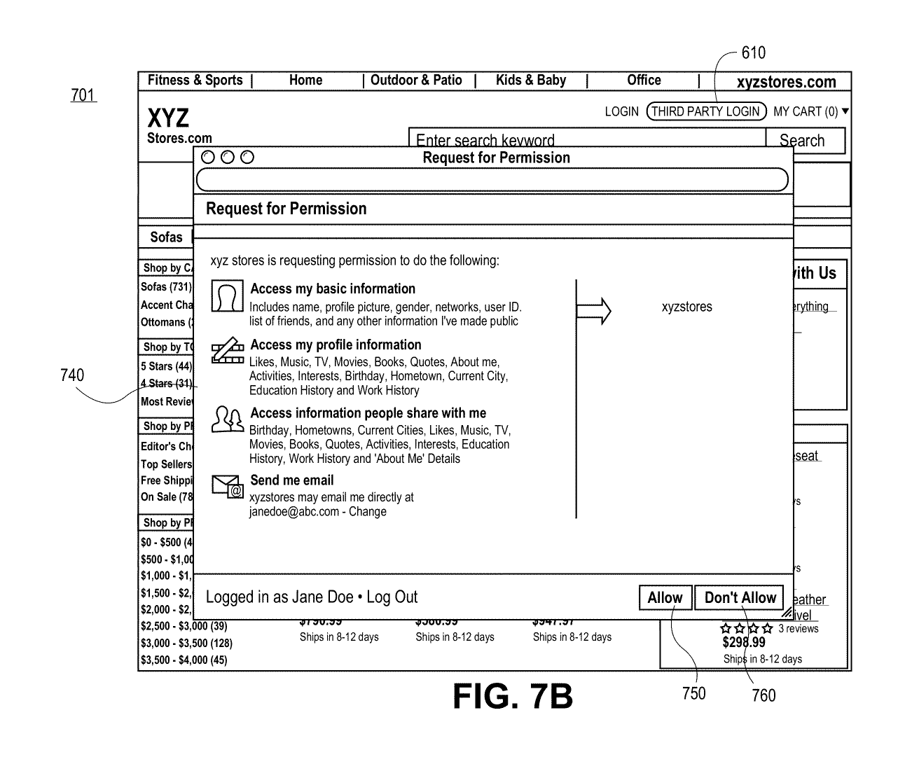

The checkout user interface 700 of FIG. 7A depicts an exemplary user interface via which the user may purchase, for example, one or more products provided to the user via, for example, user interface 600. Checkout user interface 700 may include a window 720 providing various checkout methods, such as directly logging into the website by manually entering, for example, an email address and/or password, checking out as a guest, or logging in with third party credentials via selection of third party login button 610.

Selection of third party login button 610 via user interface 600 and/or checkout user interface 700 may cause the display of a permission request user interface, such as request for permission request user interface 701 as depicted in the FIG. 7B. Request for permission user interface 701 may enable the user to grant permission for the third party Web server to access the user account, such as user account 155, associated with the user. Request for permission user interface 701 may include a list of one or more permission options 740 available to the user, enabling the user to select specific data associated with the user account the third party Web server may access. For example, request for permission user interface 701 may include an option enabling the third party Web server to access basic information, social profile information, information people share with the user, and a link to send an email to the user. Exemplary basic information may include information the user has made publicly available, such as the user's name, social profile picture or avatar, gender, user ID, and/or lists of contacts. Exemplary profile information may include information the user has made privately available to one or more contacts or friends, such as personal preferences, interests or likes (e.g., favorite music, television shows, books, quotations, activities, geographic locations, vacation destinations, work history, education, geo-location check-ins, etc.).

Permission request user interface 701 may also include one or more buttons or links which, when selected by the user, grant or refuse a type of permission to the third party Web server. Exemplary buttons include “allow” button 750 and “don't allow” button 760. In some cases, the user may only have the option to permit access to all or none of the data options presented in a binary fashion.

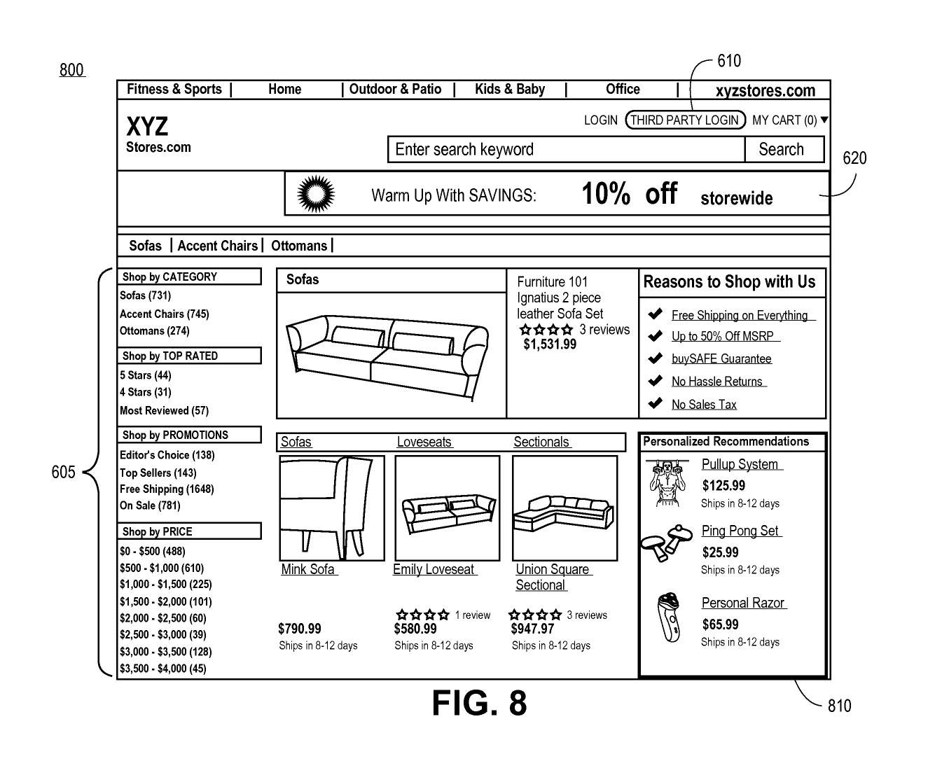

User interface 800 of FIG. 8 is similar to user interface 600 with the exception of a list of personalized recommendations 810. In some embodiments, user interface 800 may include a list of personalized discounts and/or personalized advertisements. List of personalized recommendations 810 may include, for example, one or more products or services selected for recommendation to the user based on an interest, or interests, or characteristic(s) associated with the user as determined by one or more methods disclosed herein.

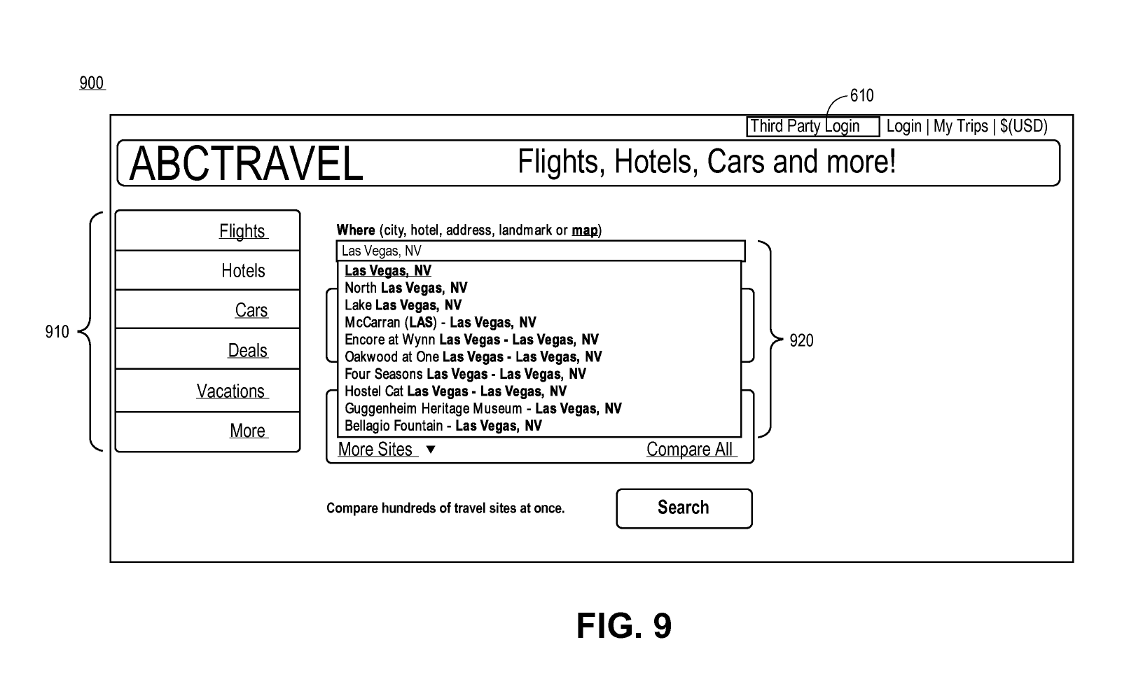

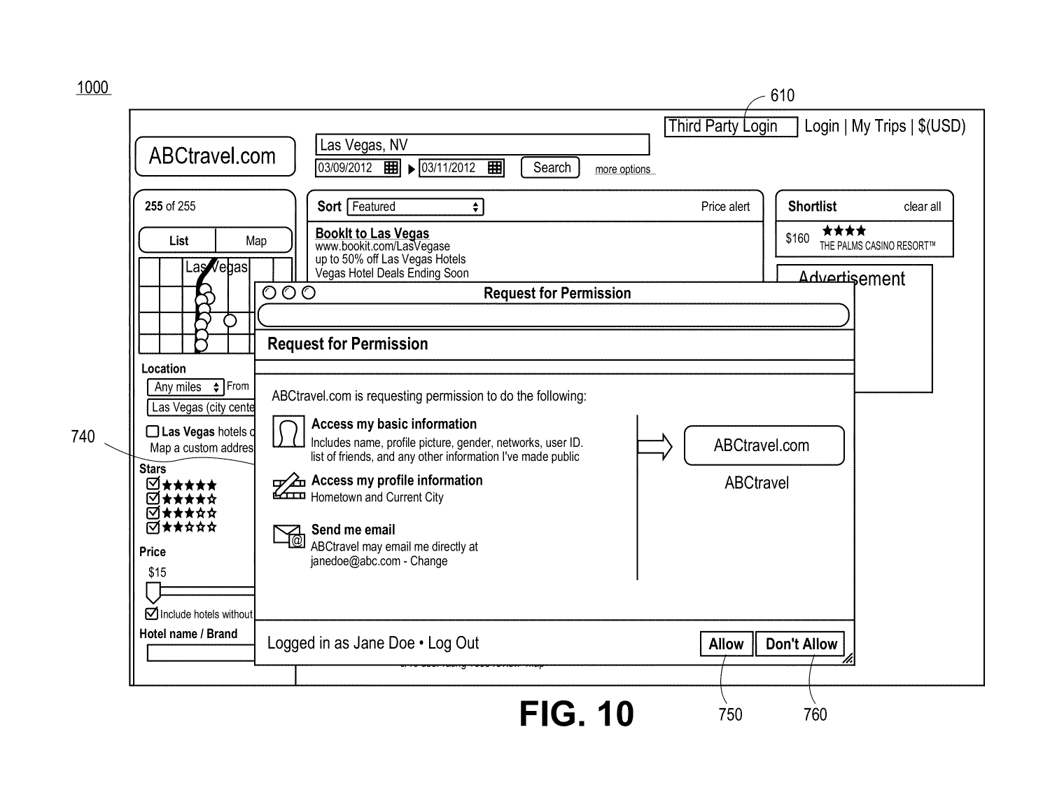

User interface 900 of FIG. 9 depicts an introductory Web page for a third party Web server associated with a travel agency website (e.g., Expedia™, Orbitz™, or Priceline™). User interface 900 includes a list of travel categories 910 that includes selectable links to information associated with the respective categories. Exemplary travel categories include flights, hotels, cars, deals, vacations, and more. Once a search term is entered, a list of suggested items 920 corresponding to the search term may be provided on user interface 900. In the example depicted in FIG. 9, the search term “Las Vegas” was entered and corresponding list 920 includes the names and locations of various hotels available in Las Vegas, Nev. When the user selects third party login button 610 as provided by user interface 900, a permission request user interface 1000 may be provided to the user as shown in FIG. 10. Permission request user interface 1000 may be similar to permission request user interface 701 with the exception that it is tailored to accommodate the design preferences of the third party Web server providing user interface 900.

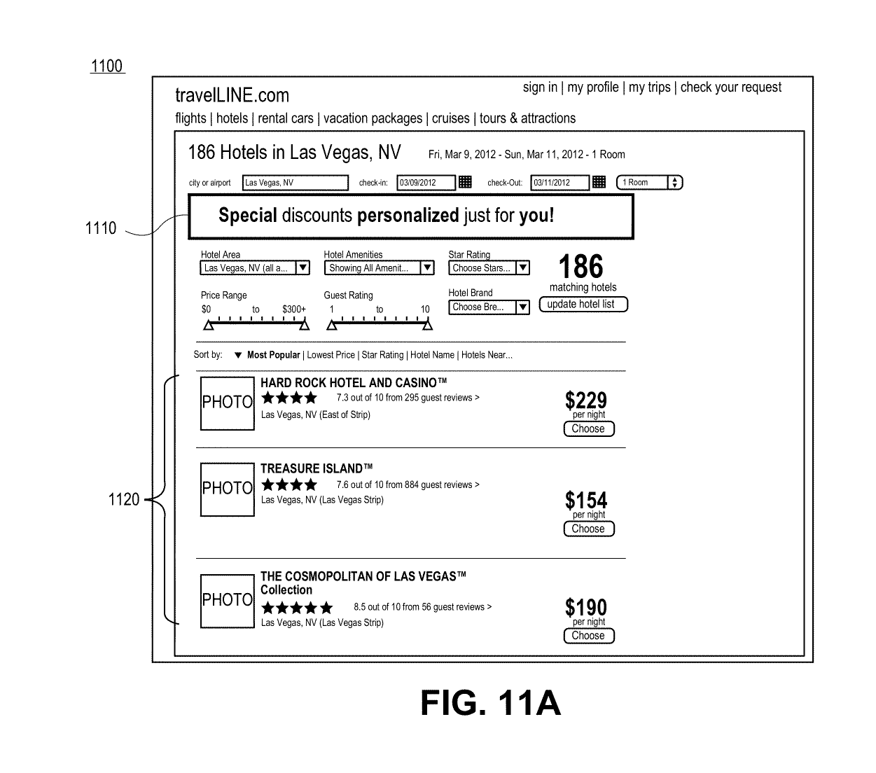

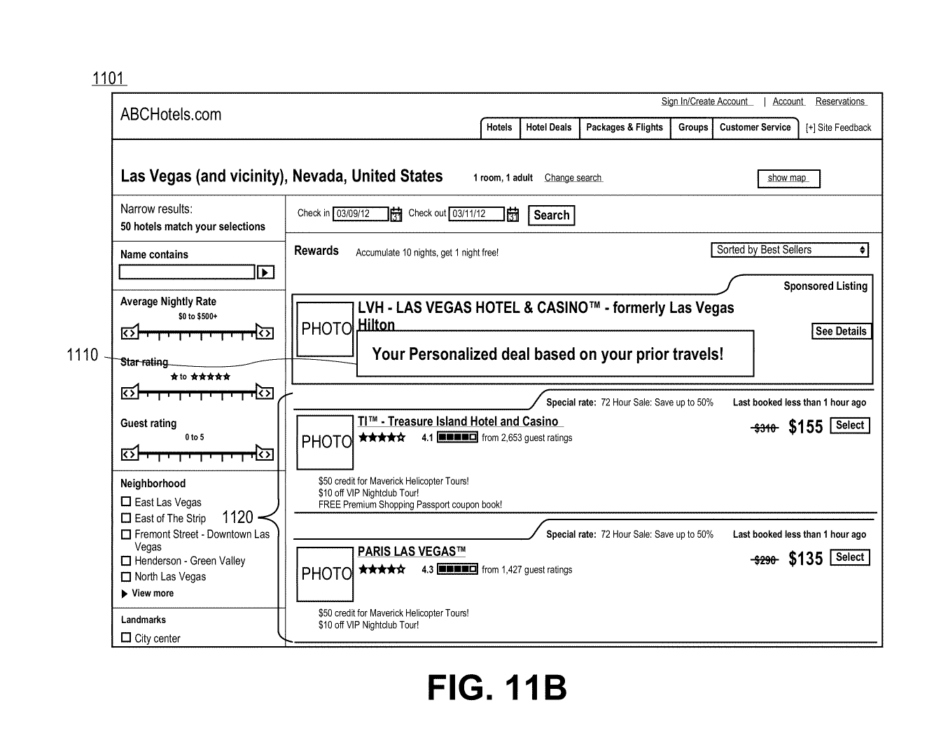

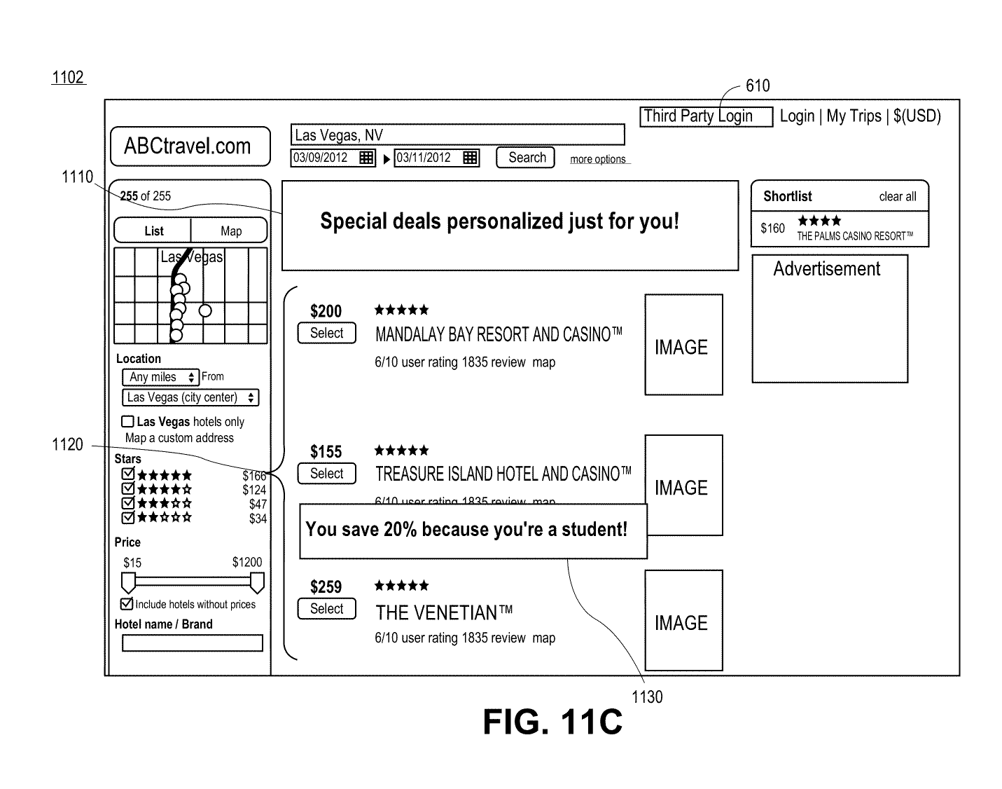

FIGS. 11A-11C depict exemplary personalized user interfaces 1100, 1101, and 1102 provided to the user following selection of third party login button 610 as provided by user interface 900 and selection of “allow” button 750 as provided by permission request user interface 1000. User interface 1100 displays a heading 1110 and a list of personalized offers or “deals” 1120. Heading 1110 may indicate that the offers included in list 1120 are personalized for the user and, on some occasions, may indicate how the offers are personalized. List of exclusive personalized offers 1120 may include one or more offers that are, for example, selected and/or personalized responsively to the determination of one or more interests and/or characteristics associated with the user according to one or more of the methods disclosed herein.

Heading 1110 of user interface 1101 as shown in FIG. 11B indicates how the offers displayed in offer list 1120 are personalized based on, for example, the prior travel of the user as determined according to one or more of the methods disclosed herein. Heading 1110 also demonstrates to the user the context of the recommendations and offers made to her. User interface 1102 as shown in FIG. 11C includes a heading 1110 and list of offers 1120 and a message 1130 indicating how the offers and offer prices are personalized for the user responsively to interests and/or characteristics associated with the user using processes 300 and 400. In this case, process 400 determines the user's status or characteristic as a student, which in turn qualifies said user for a twenty percent discount off the normal cost of the offers displayed in list 1120. A user's interests and/or characteristics (e.g., her age and/or the age of her friends, her marital status and/or the marital status of her friends, her gender, etc.) or membership in, or association with, a group or club may be used to determine a level of price personalization, such as eligibility for certain discounts, for one or more offers.

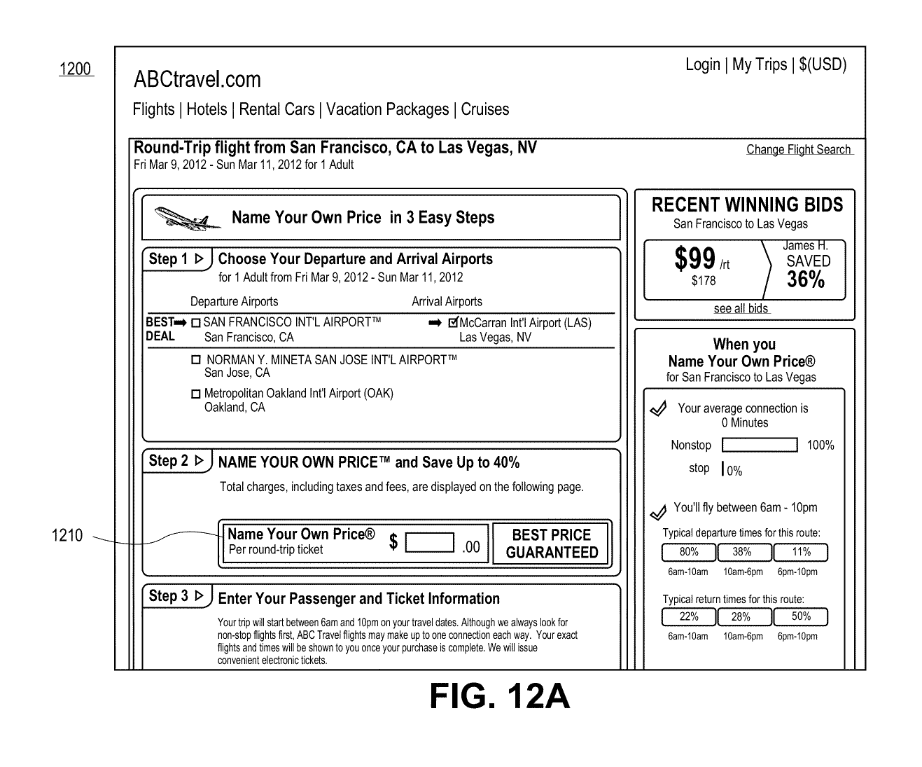

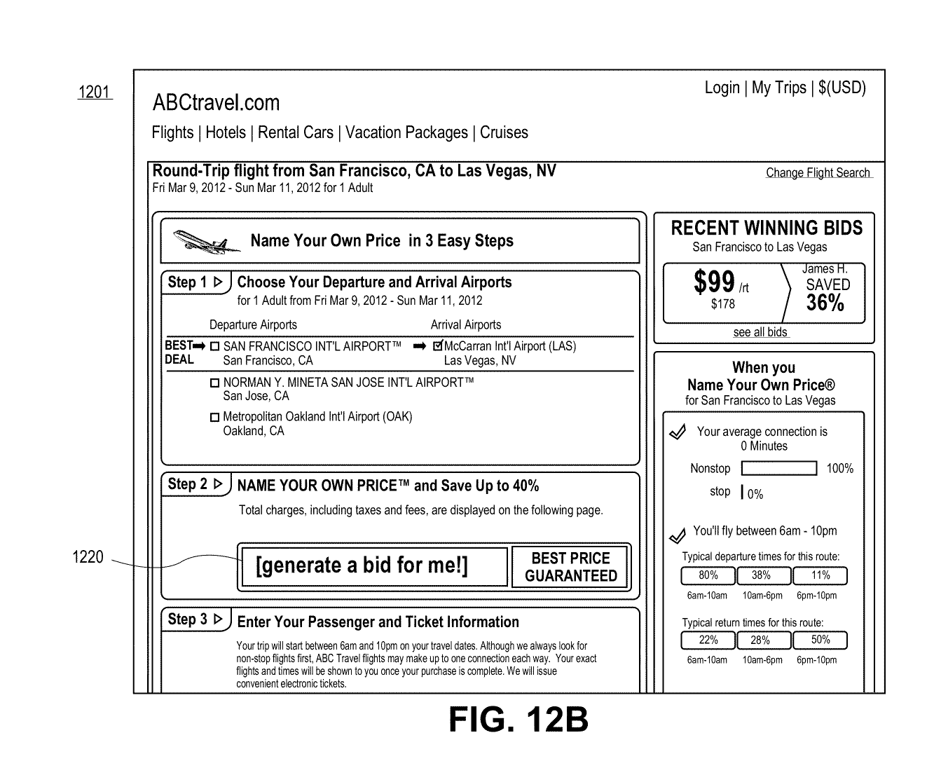

FIG. 12A depicts an offer to purchase, or bidding, user interface 1200. Exemplary bidding user interfaces provided by a third party Web server include Priceline.com™. In some embodiments, a user may interact with an opaque market in which a user is not advised of the price or vendor of an item prior to the user's bidding on the item via user interface 1200. Via user interface 1200, a user may enter a bid for, or offer to purchase, an item by entering, for example, a dollar amount into text box 1210 and submitting the bid/offer.

In some cases, a third party Web server or business may generate a bid on behalf of a user upon the user's request. FIG. 12B depicts a user interface 1201 where a user may request that a bid be prepared on her behalf and submitted to the entity operating a bidding user interface 1201 via selection of a “generate a bid for me” button or like tool 1220. Bids may be generated for a user responsively to, for example, analysis of personal information associated with the user via any of the processes described herein.

Hence methods for determining a user interest and/or characteristic have been herein disclosed.

1. A method comprising:
receiving at a processor permission to access personal information associated with a user from a user account stored in a database operated by a third party via an interface communicatively coupled to the processor and the database;
accessing, by the processor, the personal information;
evaluating, by the processor, the personal information using a previously generated concept graph relating a plurality of words and concepts to one another; and
determining, by the processor, an interest or a characteristic of the user based on the evaluation.

2. The method of claim 1, further comprising:
determining, by the processor, a recommendation based on the interest or characteristic; and
providing, by the processor, the recommendation to the user or a third party.

3. The method of claim 1, further comprising:
determining, by the processor, a term of an offer for presentation to the user based on the interest or characteristic; and
providing, by the processor, the term to the user or a third party.

4. The method of claim 1, further comprising:
determining, by the processor, a price sensitivity of the user to an offer based upon the interest or characteristic; and
providing, by the processor, the price sensitivity to a third party.

5. The method of claim 1, further comprising:
determining, by the processor, a personalized price for an offer for the user based on the evaluation.

6. The method of claim 1, further comprising:
determining, by the processor, a value of the user to a third party advertiser responsively to the evaluation.

7. The method of claim 1, further comprising:
determining, by the processor, a value of an endorsement of a product by the user to a third party associated with the product responsively to the evaluation.

8. The method of claim 1, wherein the third party operating the database storing the personal information is a social media service or a social network.

9. The method of claim 1, further comprising:
storing, by the processor, the concept graph, a personal profile, or the interest or characteristic in a database.

10. The method of claim 1, further comprising:
providing, by the processor, the interest or characteristic to the user or a third party.

11. The method of claim 1, wherein the interest or characteristic is associated with a relationship, a product, an item, a service, a piece of content, a geographic location, a hobby, a skill, an experience, a preference, an interest, a characteristic or an event.

12. The method of claim 1, further comprising:
determining, by the processor, a probability that a user will act upon an offer based on the interest or characteristic.

13. The method of claim 1, further comprising:
analyzing, by the processor, interactions of the user with user account; and
updating, by the processor, the concept graph responsively to the analysis.

14. The method of claim 1, further comprising:
validating, by the processor, an identity, a status, or a characteristic of the user based on the evaluation.

15. The method of claim 1, further comprising:
providing, by the processor, a notification to a third party responsively to the determined interest and characteristic.

16. The method of claim 1, further comprising:
generating, upon receiving a request from the user by the processor, a bid to purchase a good or service for the user responsively to evaluation.

17. A method comprising:
receiving at a processor permission to access personal information associated with a user from a user account stored in a database operated by a social networking service via an interface communicatively coupled to the processor and the database;
accessing, by the processor, the personal information;
evaluating, by the processor, the accessed personal information to determine a probability that an interest or a characteristic are associated with the user based on the evaluation; and
providing, by the processor, the probability to a third party.

18. The method of claim 17, further comprising:
determining, by the processor, a recommendation based on the interest, characteristic, or probability; and
providing, by the processor, the recommendation to the third party.

19. The method of claim 17, further comprising:
determining, by the processor, a personalized price for an offer directed to the user based on the evaluation.

20. A system comprising:
a processor configured to communicate with a source of concept graph information via a communication port, receive permission to access personal information associated with a user from the user via a user interface communicatively coupled to the processor, access the personal information, generate a personal profile of the user based on the accessed information, evaluate the personal profile using a concept graph relating a plurality of key words and concepts to one another, and determine an interest or a characteristic of the user based on the evaluation;
the interface communicatively coupled to the processor and configured to enable the processor to communicate with at the user or the third party via a communication network; and
the communication network configured to enable the processor to communicate with the user or the third party via the interface.

21. A method of providing a user of a web site with a proposal for purchase of a selected good or service at a specified price, the method comprising:
responsive to the user's visit to the web site, automatically retrieving user information from a social network profile associated with the user by a processor, access to the social network profile associated with the user being facilitated through provision, by the user, of information sufficient for a retrieval process associated with the web site to satisfy authentication means employed by a social network associated with the social network profile;
using the user information and a concept graph, automatically constructing a user profile that defines the user by the processor, the concept graph being a construct that relates concepts, terms, and phrases to one another, the user profile thereby defining the user in terms sufficient to permit automated selection of proposals, each at a respective specified price, deemed likely to be of interest to the user; and
presenting one or more of the proposals for consideration by the user by the processor, each proposal being priced uniquely for the user according to the user profile constructed from the user information.
